(19) United States
(12) Patent Application Publication
(10) Pub. No.: US 2016/0190627 A1
(43) Pub. Date: Jun. 30, 2016

(54) Filtration-Active Fuel Cell

(71) Applicants: BADEN-WÜRTTEMBERG STIFTUNG GGMBH, Stuttgart (DE); ALBERT-LUDWIGS-UNIVERSITÄT FREIBURG, Freiburg (DE)

(72) Inventors: Joana DANZER, Freiburg (DE); Sven KERZENMACHER, Freiburg (DE)

(21) Appl. No.: 14/907,743

(22) PCT Filed: Jul. 28, 2014
(86) PCT No.: PCT/EP2014/002059

§ 371 Date: Jan. 28, 2016

(30) Foreign Application Priority Data
Jul. 30, 2013 (DE) 10 2013 012 663.0

(51) Int. Cl. H01M 8/16; H01M 4/86; C02F 3/28; H01M 4/90

(52) U.S. Cl. CPC H01M 8/16; H01M 4/9016; H01M 4/8673; C02F 3/28

(57) ABSTRACT

A filtration-active fuel cell and the use thereof in the treatment and processing of fluids, in particular liquids, wherein the filtration-active layer of a membrane filter is simultaneously used as an anode of a fuel cell.

The present invention relates to a filtration-active fuel cell and also its use in the treatment and processing of fluids, in particular liquids. The present invention relates in particular to a filtration-active fuel cell in which the filtration-active layer of a membrane filter for the treatment and processing of fluids, in particular liquids, is utilized at the same time as anode of a fuel cell.

Membrane filtration is among the most important methods of separation of materials, and various membrane processes are available. These are distinguished basically according to their retention capability and the driving force to be applied. Depending on the respective field of use, microfiltration (MF), ultrafiltration (UF), nanofiltration (NF) and reverse osmosis (RO) are employed in the field of water and wastewater treatment, with these membrane processes being classified according to their retention capability based on the respective pore size or the cut-off value. The cut-off value or “molecular weight cut-off” (MWCO) is used in membrane technology to characterize ultrafiltration and nanofiltration membranes and also reverse osmosis in respect of their retention capability.

Even though there is no strict classification of the various types of membrane in the literature, nanofiltration membranes have become established between ultrafiltration and reverse osmosis in the field of membrane technology. A rough classification of the various types of membrane can be summarized as follows. Microfiltration membranes are generally classified according to their pore size which is in the range from about 0.1 to 1 μm. Ultrafiltration membranes, which are classified both according to their pore size and MWCO value, have a pore size of from about 0.004 to 0.1 μm or an MWCO of from 2000 to 200 000 dalton (Da). Nanofiltration membranes are used for retaining multiply charged ions and molecules in the molar mass range from about 200 to 1000 Da and reverse osmosis serves for retaining dissolved materials smaller than 200 Da.

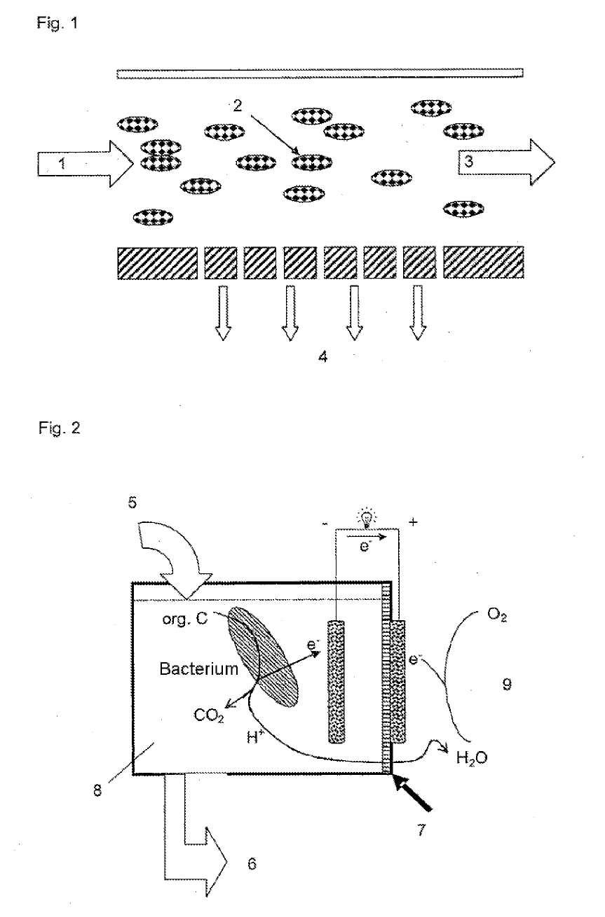

Membrane filtration, as is depicted by way of example in FIG. 1, is a key technology in the field of water and wastewater treatment, in particular for applications in which the purified wastewater is to be reused, for example in a production process. The process is based on the combination of a biological purification stage in which the biological water contamination is degraded microbially aerobically or else anaerobically, with a subsequent membrane separation in which the bacterial biomass is separated from the purified wastewater and retained in the bioreactor. Such systems are also referred to as membrane bioreactors or membrane activation reactors (MAR). The great retention capability of membrane filtration results in a high sludge maturity and thus a water which has been purified to a high degree and is largely free of particles and germs. Thus, for example, a completely closed water circuit can be realized in an industrial production process. The MAR technology is accordingly a widely used alternative to conventional purification processes in industrial wastewater purification.

However, this wastewater treatment process has the disadvantage of high capital costs and a high specific energy consumption which arises predominantly from the electric pump energy required. Accordingly, this technology has hitherto been employed especially when the purified wastewater has to meet demanding requirements or when, for example, compact water treatment plants are necessary because of lack of space or high land prices. Examples are the treatment of wastewater from the pharmaceutical and food industry, but the MAR technology is also employed for domestic waste landfills or on ships.

Membrane filtration processes are classified in principle in respect of their mode of operation into dead-end processes (static filtration) and cross-flow processes (transverse flow filtration). The schematic depiction of a membrane filtration shown in FIG. 1 shows a cross-flow process in which blocking of the pores is avoided by the continuous flow over the filtration-active layer perpendicular to the permeate flow. The material mixture to be treated is generally referred to as feed.

As a new energy-efficient process for wastewater purification, research is currently being carried out on microbial fuel cells (MFC) in which exoelectrogenic bacteria “breathe” with the anode of a fuel cell instead of with atmospheric oxygen, as is outlined in FIG. 2. Microbial fuel cells typically consist of two separate regions, viz. the anode compartment and the cathode compartment, which are separated by an electrically insulating separator structure which is nevertheless permeable to ions, for example a proton exchange membrane (PEM). These microbial fuel cells allow the wastewater purification to be combined simultaneously with power generation, with carbon-containing organic compounds being converted into carbon dioxide (CO₂) at the anode by the mass transfer of exoelectrogenic bacteria. The electrons liberated here are transferred to the anode and flow with liberation of electric energy through an external load circuit to the cathode. Here, atmospheric oxygen from the gas phase as terminal electron acceptor is reduced together with protons to form water.

The present-day state of the art still does not allow commercial utilization of this technology since the achievable power densities do not yet ensure economically sustainable operation. The research work is accordingly focused on increasing the power densities, reducing the costs, using biological fuel cells to supplement other processes or at the same time to produce a product such as sodium hydroxide, hydrogen peroxide, ethanol, hydrogen, etc. (cf. Hamelers H. V. M. et al. “New Applications and Performance of Bioelectrochemical Systems” Appl. Microbiol. Biotechnol., 85 (2010) 1673-1685).

Furthermore, current studies are examining various electrode materials which are intended to improve the efficiency of microbial fuel cells. Hosseini G. et al. “A dual-chambered microbial fuel cell with Ti/nano-TiO₂/Pd nano-structure cathode” J. Power Sources, 220 (2012) 292-297, describe a Ti/nano-TiO₂/Pd-nano-structured electrode which is used as cathode in combination with a graphite anode and an ion-conducting membrane in a microbial fuel cell. Moreover, Ozkaya B. et al. “Bioelectricity production using a new electrode in a microbial fuel cell” Bioprocess Biosyst. Eng., 35 (2012) 1219-1227, likewise describe a microbial fuel cell in which a Ti—TiO₂ electrode is used as anode.

In addition, Pocaznoi D. et al. “Stainless steel is a promising electrode material for anodes of microbial fuel cells” Energy Environ. Sci., 5 (2012) 9645-9652, describe the use of stainless steel as anode material in a microbial fuel cell. Wei J. et al. “Recent Progress in Electrodes for Microbial Fuel Cells” Bioresour. Technol., 102 (2011) 9335-9344, examine the use of carbon materials in microbial fuel cells and Michaelidou U. et al. “Microbial Communities and Electrochemical Performance of Titanium-Based Anodic Electrodes in a Microbial Fuel Cell” Appl. and Environ. Microbiol., 77 (2011) 1069-1075, describe the use of titanium-based anodes.

To increase the power densities, the development of “air-breathing” cathode, by means of which atmospheric oxygen from the gas phase can be electrochemically converted efficiently and without use of auxiliary energy, is among the current challenges for a microbial fuel cell. The key to an air-breathing cathode is the three-phase boundary between electrode, electrolyte and gas phase at which the electrochemical reaction takes place. The formation of salt deposits from the salts dissolved in the wastewater has been found to be particularly disadvantageous when using air-breathing cathodes in microbial fuel cells. Such deposits block the transport paths and the reaction surface of the cathode and lead to a rapid loss of power. In addition, a pH gradient is established between anode and cathode during operation of the fuel cell and this likewise impairs the performance of the system (cf. Popat S. C. et al. “Importance of OH-Transport From Cathodes in Microbial Fuel Cells” Chemsuschem, 5 (2012) 1071-1079).

The formation of a salt crust and a pH gradient can in principle be countered by continuous irrigation of the cathode surface, as described in Aelterman P. et al. “Microbial Fuel Cells Operated With Iron-Chelated Air Cathodes” Electrochim. Acta, 54 (2009) 5754-5760. However, this is disadvantageously associated with an additional outlay in terms of apparatus and energy.

Finally, attempts have been made in the prior art to counter the above-described disadvantage of membrane filtration in water and wastewater treatment, i.e. the high specific energy consumption of the MAR technology, by combining the MAR technology with microbial fuel cells. In this way, part of the electric energy necessary for operation of a membrane bioreactor is to be taken directly from the organic contamination of the wastewater to be treated. Overall, the energy efficiency of the membrane process should thus be increased and the operating costs should be reduced, so that membrane filtration could become economical in a wider range of uses.

For example, Logan B. E. “Microbial fuel cells”, John Wiley & Sons, Inc., Hoboken, N. J., 2008 and Logan B. E. et al. “Microbial Fuel Cells: Methodology and Technology”, Environ. Sci. Technol., 40 (2006) 5181-5192 describe the combination of an MAR with an MFC reactor. Here, the MAR technology is coupled with an MFC, with the two reactors being connected in series. This is thus not an integrated system of the two technologies in the actual sense. Similarly, Wang Y.-P. et al. “A microbial fuel cell-membrane bioreactor integrated system for cost-effective wastewater treatment” Appl. Energy, 98 (2012) 230-235, report an integrated system, although an actual integrated system is not present because the individual reactors are connected in series.

A further disadvantage of this technology known in the prior art, in which the respective reactors are connected in series, however, is that the complex reactor system is associated with high capital costs and a high outlay in terms of apparatus.

The Chinese patent application CN 102 616 918 A describes a directly coupled MAR-MFC reactor for wastewater purification, in which a biofilm is formed on the cathode. As a result, the cathode of the MFC can simultaneously be used as filtration-active layer of the MAR. A comparable principle is described in Liu J. et al. “Integration of Bio-Electrochemical Cell in Membrane Bioreactor for Membrane Cathode Fouling Reduction Through Electricity Generation” J. Membr. Sci., 430 (2013) 196-202. Wang Y.-K. et al. “Development of a Novel Bioelectrochemical Membrane Reactor for Wastewater Treatment” Environ. Sci. Techn. (2011) 9256-9261, also disclose a mesh which is made of stainless steel with a biofilm formed thereon and serves both as cathode of the MFC and as filtration-active layer of the MAR. Here, the membrane filtration process is carried out in dead-end operation.

In these devices, in which the cathode of the MFC is simultaneously used as filtration-active layer of the MAR, bacteria colonize the cathode and function as catalyst for the reduction of oxygen. However, the underlying mechanism of energy generation in these systems is understood only incompletely (cf. Harnisch F. et al. “From MFC to MXC: Chemical and Biological Cathodes and Their Potential for Microbial Bioelectrochemical Systems” Chem. Soc. Rev., 39 (2010) 4433-4448).

Proceeding herefrom, it is an object of the present invention to provide a filtration system for the treatment and processing of fluids, in particular liquids, which overcomes the known disadvantages and restrictions of the prior art. In particular, it is an object of the present invention to provide a high-performance filtration apparatus which can be used in an efficient way without a great outlay in terms of apparatus and energy in the treatment and processing of liquids.

This object is achieved by the subject matter characterized in the claims.

In particular, a fuel cell for the filtration of fluids, in particular of liquids (hereinafter also referred to as “filtration-active fuel cell”), comprising a filtration-active, electrically conductive membrane layer which simultaneously represents the anode of the fuel cell, a cathode which is preferably an air-breathing cathode, a fluid-permeable separator which separates the cathode spatially and electrically from the anode and an active species which is capable of oxidizing materials which are present in the feed and serve as energy carriers and transfer the electrons liberated to the anode, is provided. Here, for the purposes of the present invention, the term “filtration-active fuel cell” means that at least the anode and the separator of the fuel cell of the invention are permeable to fluids, in particular liquids.

According to the present invention, the filtration-active fuel cell can have a configuration similar to a conventional fuel cell which, as an electrochemical cell, converts the chemical reaction energy of a continuously supplied fuel, usually in the form of hydrogen or comparable compounds such as formic acid or methanol, and an oxidant into electric energy. It is also possible, according to the present invention, for, for example, electric energy to be additionally supplied to the filtration-active fuel cell, as a result of which the fuel cell of the invention can be operated as an electrolysis cell for producing, for example, hydrogen.

According to a preferred embodiment, the filtration-active fuel cell of the invention is a biofuel cell. Here, the term “biofuel cell” refers to a system in which materials present in the feed, for example substances originating from biological systems and derivatives thereof, are oxidized and thus serve as energy carriers. According to the present invention, these energy carriers include, in particular, carbon-containing compounds, which can also be termed organic compounds.

The active species is, according to the invention, able to oxidize materials present in the feed. Here, these materials serve as energy carriers. Depending on the respective activation energy which is necessary to oxidize these materials, the active species can also be referred to as catalyst. Consequently, when the activation energy of the electron transition is low enough, the active species basically does not have to have any catalytic activity according to the present invention.

The filtration-active fuel cell of the invention preferably comprises a catalytically active species which is capable of oxidizing materials which are present in the feed and serve as energy carriers and transferring the liberated electrons to the anode.

Further preferred embodiments of the present invention are described by way of example below with the aid of accompanying figures. The figures show

FIG. 1: A schematic depiction of membrane filtration according to the cross-flow process

FIG. 2: A schematic depiction of wastewater purification combined with power generation in a microbial biofuel cell

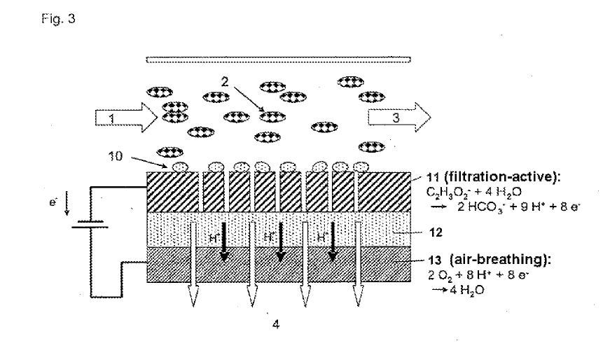

FIG. 3: A schematic depiction of a preferred embodiment of the filtration-active fuel cell of the invention

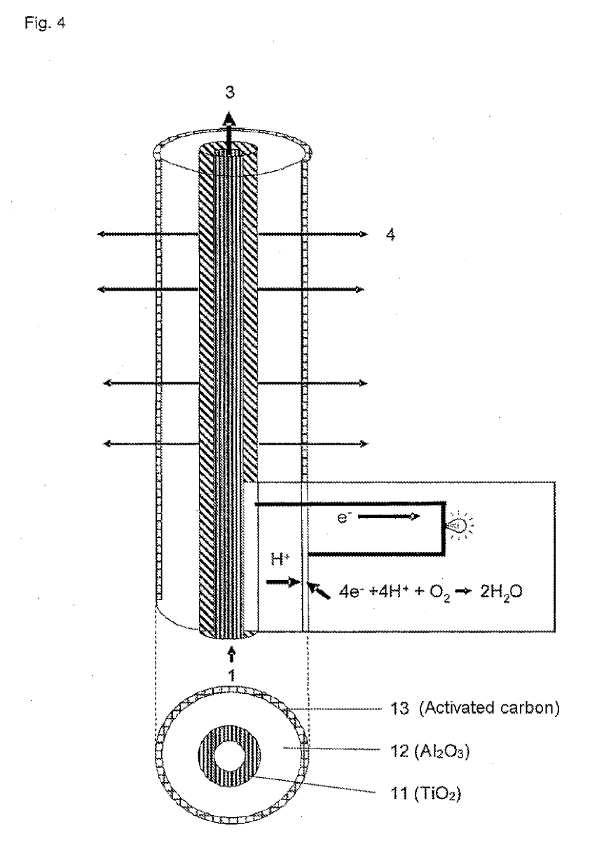

FIG. 4: A schematic depiction of a preferred embodiment of the filtration-active fuel cell of the invention

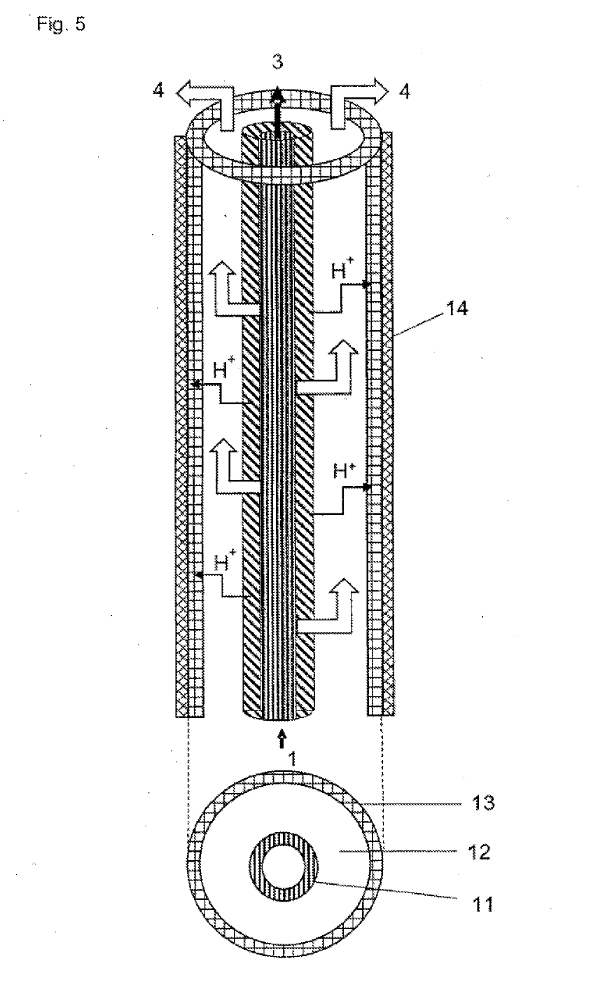

FIG. 5: A schematic depiction of a preferred embodiment of the filtration-active fuel cell according to the invention

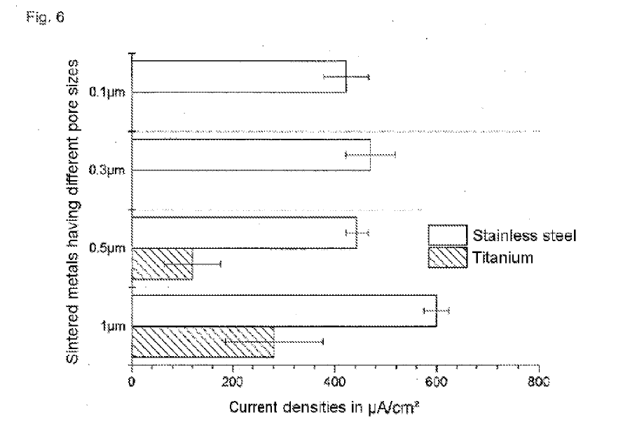

FIG. 6: Current densities of various filter materials at 0 V vs. SHE in a half-cell experiment (triplicates with standard deviation, or duplicates at 0.1 μm porosity)

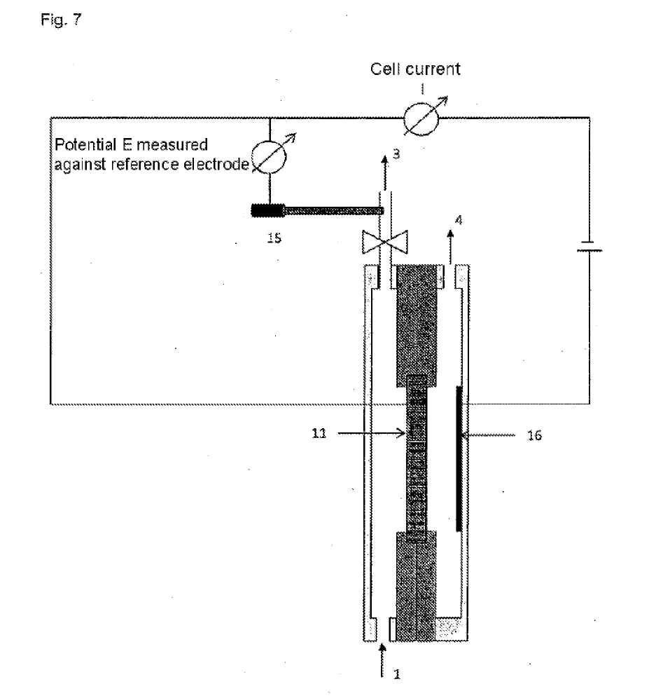

FIG. 7: A flow diagram of a working example, with the electric connections of the anode operated as half cell not being shown for reasons of clarity.

As described above, according to a preferred embodiment of the present invention the filtration-active fuel cell of the invention comprises a catalytically active species which oxidizes the materials present in the feed at the anode, so that these serve as energy carriers. According to the present invention, it is possible to use not only microorganisms or enzymes as catalysts but also inorganic catalysts as catalytically active species. When microorganisms, for example bacteria, are used as catalytically active species, the fuel cell according to the invention can also be described as a microbial fuel cell. In this case, exoelectrogenic bacteria are, for example, preferably deposited in the form of a biofilm on the filtration-active membrane layer. Exoelectrogenic bacteria convert carbon-containing organic compounds into CO₂ at the anode by means of their metabolism. The electrons liberated are transferred to the anode and flow with liberation of electric energy through an external load circuit to the cathode.

According to the present invention, exoelectrogenic bacteria known in the prior art can in principle be used. Examples which may be mentioned are bacteria of the genus Shewanella or the genus Geobacter.

However, in a further embodiment of the present invention, the microorganisms such as exoelectrogenic bacteria do not have to be deposited in the form of a biofilm on the filtration-active membrane layer. It is also possible to use specific microorganisms, preferably bacteria, which allow “indirect electron transfer”. In the case of indirect electron transfer, mediators which take on the role of a “redox shuttle” are secreted by these specific microorganisms. The microorganisms reduce these mediators at the end of their respiratory chain, the mediator diffuses or converges to the anode, releases the electrons there and can subsequently be reduced again by the microorganisms. When endogenic mediators are used, the microorganism therefore does not have to adhere directly to the anode. A nonlimiting example of such specific microorganisms which allow indirect electron transfer on the basis of secreted mediators and thus do not have to adhere to the anode is the bacterium Pseudomonas aeruginosa, which produces pyocyanin as mediator. It is likewise known that the bacterium Shewanella oneidensis secretes flavins which serve as mediator for electron transfer (cf. Marsili, E. et al. “Shewanella secretes flavins that mediate extracellular electron transfer” Proc. Natl. Acad. Sci. U.S.A. 105 (2008) 3968-3973).

The advantages of the fuel cell of the invention are also achieved when using enzymes as catalysts. According to the invention, immobilized enzymes, free enzymes or enzyme-mediator systems can serve as catalysts at the anode. The introduction of enzyme-secreting fungi, yeasts or bacteria into the fuel cell of the invention, which in this case can also be referred to as an enzymatic fuel cell, makes it possible to generate energy during filtration, as a result of which the operating costs of membrane filtration in the treatment and processing of liquids are advantageously reduced here, too.

As described above for the embodiment of a microbial fuel cell, it is also possible in the case of an enzymatic fuel cell according to the invention using free enzymes or enzyme-mediator systems to generate electric energy by decomposition of organic substances at the anode, which here likewise serves as electron acceptor, without a biofilm having to be formed on the anode.

According to the present invention, it is additionally possible to use inorganic catalysts as catalytically active species. In this embodiment of the present invention, abiotic catalysts are used which are arranged on the anode of the fuel cell of the invention, as in the case of conventional hydrogen fuel cells. The anode material is preferably coated with noble metals, for example platinum or palladium, or activated carbon. These abiotic catalysts allow electrooxidation of oxidizable materials present in the feed. In this embodiment, substances originating from biological systems and derivatives thereof are preferably oxidized as energy carriers. These energy carriers can also be referred to as biofuels.

In addition, it is possible when using abiotic catalysts for interfering products present in the feed to be reacted in a targeted manner, as a result of which it is not only possible to generate electric energy but at the same time convert these interfering products into desired (end) products. An example which may be mentioned is the processing of drinkable liquids, in particular alcohol-containing and also alcohol-free beverages. Preference is given to processing fruit juices, in particular apple juices, which are firstly clarified by the membrane filtration and at the same time freed of undesirable materials by means of a specific abiotic catalyst deposited on the anode. For example, in the case of an apple juice, the unwanted phenols and/or polyphenols which are responsible for brown discoloration of the apple juice can be oxidized. This surprisingly makes it possible for, apart from the actual separating function, interfering products present in the feed to be decomposed in a targeted manner and at the same time for electric power to be generated.

Abiotic catalysts are essentially stable in the long term and tolerant to extreme operating conditions such as an extreme pH or high temperatures.

In a preferred embodiment of the filtration-active fuel cell of the invention, abiotic catalysts are used in combination with a microbial or enzymatic fuel cell.

In terms of separation principle, the filtration-active fuel cell of the invention can have a cross-flow or dead-end configuration. When the filtration-active fuel cell is used in dead-end filtration, this makes a higher energy generation potential possible, since the pump power required is lower than in the cross-flow process.

In a preferred embodiment of the present invention, the anode of the filtration-active fuel cell of the invention is present in the form of a membrane operated in cross-flow. This principle is shown in FIG. 3, in which exoelectrogenic bacteria are shown by way of example as active species. FIG. 3 shows a schematic depiction of a preferred embodiment of the fuel cell of the invention, in which the filtration-active layer is simultaneously used as anode of a microbial fuel cell. The permeate flow transports the hydrogen ions (H⁺ ions) formed at the anode to the cathode and thus counters the buildup of a pH gradient. In addition, the deposition of salt encrustations on the cathode structure is advantageously prevented.

The difference between the principle according to the invention, in which the anode of the fuel cell is simultaneously used as filtration membrane, and the operating conditions known from the prior art, in which the cathode is used as filtration-active layer, can be clearly explained with the aid of this depiction shown in FIG. 3. In comparison with the prior art, according to the present invention the anode of the fuel cell simultaneously serves as filtration membrane, i.e. the anode is filtration-active due to its porous structure. By interaction with materials present in the feed, the active species generates electrons which are transferred to the anode. These electrons flow with liberation of electric energy through an external load circuit to the cathode.

The anode and cathode in the fuel cell of the invention therefore have to meet the following requirements:
an active species which can, depending on the respective activation energy of the electron transfer, be in the form of microbial, enzymatic and/or abiotic catalysts is required at the anode;
it is preferred that essentially no oxygen is available at the anode, since otherwise the active species would transfer the electrons to this and not to the electrode;
an oxidant has to be available at the cathode so as to be reduced there.

Owing to these requirements, the configurations described in the prior art, in which the cathode is used as filtration-active layer, always have the disadvantage compared to the anode that the sludge from the anode, where the bacteria or enzymes are required as catalyst, has to be transferred to the cathode, where it is then filtered off. As a result, direct juxtaposition of the anode/insulator/cathode as in the present invention is impossible or at least difficult to realize. Rather, the anode and the cathode would have to be separated spatially but nevertheless be supplied with the same wastewater/sludge. However, this means a higher outlay in terms of apparatus and energy. The spatial separation also increases the internal electrical resistance over the electrolyte of the fuel cell, which results in a lower power output. This is of great importance especially in the case of electrolytes having a low conductivity, as is frequently the case for wastewater.

As shown in FIG. 3, blocking of the pores is avoided as a result of the continuous flow over the filtration-active layer perpendicular to the permeate flow. In contrast to dead-end filtration, this makes it possible to maintain the permeate flow virtually unchanged since continuous formation of a filtercake can be avoided.

In the case where the active species is present in the form of a biofilm formed on the anode, an optimal operating point between biofilm removal and biofilm formation can also be set by means of the cross flow.

The mode of construction and the material for the filtration-active, electrically conductive membrane layer, which simultaneously represents the anode of the fuel cell of the invention, are not subject to any particular restrictions. It is merely important that the anode material is suitable for filtration, i.e. is porous, and is electrically conductive. This can be achieved according to the invention in the form of a porous and electrically conductive material or in the form of a hybrid construction in which porous (filtration-active) regions and electrically conductive regions alternate.

Various materials and constructions are suitable for the anode of the fuel cell of the invention, depending on the desired retention capability. In microfiltration (MF) and ultrafiltration (UF), the filtration material is preferably composed of a conductive polymer material, for example doped polymer materials based on polysulfone, polyether sulfone, polypropylene, polyvinylidene fluoride, polyacrylonitrile or polypyrrole. Preference is likewise given to using inorganic materials as anode material. Particularly suitable materials are carbon, for example graphite, activated carbon or carbon nanofibers, ceramics, for example TiO₂, or metals. In a particularly preferred embodiment, the anode comprises a TiO₂ ceramic or a porous sintered metal structure composed of titanium or (stainless) steel.

As suitable construction form, the anode can be present as porous body, in the form of a grid- and/or mesh-like structure or as nonwoven in the filtration-active fuel cell of the invention.

In order to increase the conductivity of the filtration-active fuel cell of the invention if necessary, should the conductivity of the anode material be insufficient, current collectors having electrical contact with the anode can additionally be introduced. These current collectors are advantageously selected from among materials which do not corrode, as a result of which the current flow of the fuel cell of the invention can be increased over a long period of time. These materials which do not corrode are preferably selected from among carbon materials, in particular graphite, chromium alloys and ferritic iron alloys.

In a preferred embodiment of the fuel cell of the invention, the filtration-active anode is in the form of a nanofiltration, ultrafiltration or microfiltration membrane, particularly preferably in the form of an ultrafiltration membrane.

In addition, the filtration-active anode can have a hybrid construction in which filtration-active regions, in particular in the form of the abovementioned filtration membranes, and electrically conductive regions alternate. This construction of the filtration-active anode advantageously allows conventional membranes which are not necessarily electrically conductive to be used. In this embodiment, materials known in the prior art can be used for the filtration-active regions. For example, materials which may be mentioned without constituting a restriction are filtration membranes based on the abovementioned polymers (undoped), in particular based on polysulfone, polyether sulfone, polypropylene, polyvinylidene fluoride, polyacrylonitrile or polypyrrole. Furthermore, mention may be made by way of example of filtration membranes based on cellulose, e.g. cellulose esters, cellulose acetate, cellulose nitrate or regenerated cellulose, or nonconductive ceramics.

The electrically conductive regions, which preferably make up at least 5%, more preferably at least 10% and particularly preferably at least 15%, of the total area, i.e. the geometric area, of the anode construction can in turn likewise be present in the form of a porous body, in the form of a grid- and mesh-like structure or as nonwoven. This embodiment of the invention makes it possible for the electrically conductive regions, which can consist of conventional materials, not necessarily to be filtration-active. In this case, the proportion of the electrically conductive regions based on the total area of the anode construction is preferably 50% or less, more preferably 40% or less and particularly preferably 30% or less.

If the anode has, as described above, a hybrid construction, the filtration-active regions which are not electrically conductive can simultaneously serve as separator. For this purpose, the layer which is not electrically conductive has to be continued below the conductive regions according to the invention as well. In this way, this layer automatically performs the task of electrical insulation between anode and cathode and an additional separator can be dispensed with. As described above, materials known in the prior art can be used for these filtration-active and electrically insulating regions.

For example, mention may be made of filtration membranes based on the abovementioned polymers and also filtration membranes based on cellulose, e.g. cellulose esters, cellulose acetate, cellulose nitrate or regenerated cellulose, or nonconductive ceramics as materials without constituting a restriction.

As stated above, essentially no oxygen should be available at the anode since otherwise the active species would transfer the electrons to this and not to the electrode. Furthermore, some suitable exoelectrogenic bacteria such as Geobacter metallireducens are strictly anaerobic. However, according to the present invention, the term “essentially” as used in this context does not imply that no oxygen is allowed to be present in the anode compartment. Depending on the configuration of the filtration-active fuel cell of the invention, the oxygen content in the anode compartment can be greater or smaller. When possibly anaerobic exoelectrogenic bacteria such as Shewanella oneidensis are used as active species, it has been found that a low oxygen content in the anode compartment has a positive influence on the growth of the bacteria, as a result of which the electric power output of the fuel cell of the invention is surprisingly improved. The oxygen content in the anode compartment at 20° C. is preferably up to 8 mg/l, more preferably up to 6 mg/l. In the embodiment according to the invention in which a small oxygen content is present in the anode compartment, this is particularly preferably in the range from 2 to 4 mg/l.

Furthermore, the fuel cell of the invention can be used in various membrane modules. These include, but without being restricted thereto, tubular modules, plate modules, rolled modules, hollow fiber modules and capillary modules, with preference being given to hollow fiber modules or tubular modules.

The fluid-permeable separator can according to the invention be, for example, in the form of an insulator layer such as a semipermeable insulator layer which separates the cathode both spatially and electrically from the anode and is permeable to ions, in particular protons. This means that the separator in the form of an insulator layer has to be electrically insulating, porous and wettable. It is not necessary for the separator material to conduct ions or be gastight. This makes it possible for the H⁺ ions formed at the anode to be transported by the permeate flow to the cathode, as a result of which buildup of a pH gradient can be prevented. For the purposes of the present invention, the term “fluid-permeable” means that the separator in the form of an insulator layer is porous, i.e. the insulator layer is permeable to liquids and gases.

According to the invention, materials known in the prior art can preferably be used for this insulator layer. These separators, which are generally referred to as proton-exchange membrane, are permeable to protons but the transport of gases, for example oxygen or hydrogen, is prevented. For example, the separator of the filtration-active fuel cell of the invention can be made either of pure polymer membranes or of composite membranes in which other materials are embedded in a polymer matrix. In addition, nanoporous and microporous Al₂O₃ ceramics can also be used as separator layer.

In a further preferred embodiment of the present invention, the separator is configured so that permeate from the anode flows through it (hereinafter also referred to as “separator through which permeate flows”). The separator through which permeate flows is preferably present as a hollow space which spatially and electrically separates the cathode from the anode, as is shown schematically in FIG. 5. In this embodiment of the filtration-active fuel cell of the invention, the permeate flow is preferably diverted in such a way that, after passage through the anode in the case of a membrane operated in cross-flow, it is once again aligned in the direction of the main flow direction of the feed, i.e. experiences a deflection by about 90°. A corresponding situation applies to the case of the filtration-active fuel cell being in the form of a membrane operated in the dead-end mode.

In this embodiment, the cathode preferably has a hydrophobic membrane which is permeable to oxygen on the surface facing away from the anode. This makes it possible for the cathode to be kept sterile and any undesirable biofilm formation to be avoided.

Like the anode of the fuel cell of the invention, too, the cathode material is not subject to any particular restriction. The cathode is preferably made of an electrically conductive polymer material or an inorganic material as described above for the anode.

The inorganic materials include, as particularly suitable materials, carbons such as graphite, activated carbon or carbon nanofibers, ceramics, for example TiO₂, or metals. In a particularly preferred embodiment, the cathode comprises activated carbon.

In a preferred embodiment of the present invention, the cathode is air-breathing. For the purposes of the present invention, the term “air-breathing” means that the cathode is in contact with atmospheric oxygen from the gas phase. Alternatively, the filtration-active fuel cell of the invention can also comprise an “immersed” cathode at which materials corresponding to the application are reduced to give desired products. Here, the term “immersed” cathode means that the cathode is in contact not only with atmospheric oxygen from the gas phase but also with atmospheric oxygen which is blown from the gas phase into the liquid phase or diffuses into the latter. Furthermore, the term “immersed” cathodes encompasses cathodes which are partially or completely surrounded by an appropriate liquid, with the liquid containing another oxidant, for example nitrate compounds, which is reduced instead of the atmospheric oxygen.

As described above, the filtration-active fuel cell of the invention can also be used as electrolysis cell when electric energy is supplied, as a result of which products can be produced in a targeted manner at the cathode. The filtration-active fuel cell of the invention can preferably be used for producing, for example, sodium hydroxide, hydrogen peroxide, ethanol and particularly preferably hydrogen.

As indicated above, known technologies frequently suffer from the problem that the salts dissolved in the wastewater lead to formation of salt deposits on the cathode, and these block the transport paths and reaction surface of the cathode and thus lead to a rapid decrease in performance.

According to the present invention, this problem is overcome by construction of the filtration-active fuel cell of the invention, since the formation of salt deposits can be suppressed by the permeate flow.

Particularly preferred embodiments of the present invention are shown in FIGS. 4 and 5. In these preferred embodiments of the filtration-active fuel cell of the invention, the filtration-active, electrically conductive membrane layer, which simultaneously represents the anode of the fuel cell, comprises TiO₂ which is provided in the form of a hollow fiber membrane. In a further particularly preferred embodiment, the anode of the fuel cell of the invention can comprise porous sintered metal structures composed of titanium or (stainless) steel. An exoelectrogenic biofilm is arranged on this anode and releases electrons to the anode as a result of the bacterial metabolism.

Furthermore, the preferred embodiment of the filtration-active fuel cell of the invention shown in FIG. 4 comprises a separator which comprises an Al₂O₃ ceramic and separates the anode from the cathode. The cathode is in the form of an activated carbon-containing sheathing of the separator. The separator can likewise preferably be in the form of porous polymers.

As stated above, the separator can also be present as a separator through which permeate flows and which separates the cathode spatially and electrically from the anode. In this modified cathode configuration, there is the opportunity of integrating a conventional air-breathing cathode with a hydrophobic membrane. In addition, additional supporting structures, for example in the form of mesh structures, can be present in order to stabilize the anode-cathode assembly in this embodiment.

According to the present invention, the filtration-active fuel cell of the invention can be produced by a process comprising the following steps:
provision of a filtration-active, electrically conductive membrane layer as anode,
provision of a cathode,
provision of a liquid-permeable separator which spatially and electrically separates the cathode from the anode and
provision of an active species at the anode, which active species is capable of oxidizing materials which are present in the feed and serve as energy carriers and transferring the electrons liberated to the anode.

In addition, the present invention provides a process for the treatment and processing of fluids, in particular liquids, wherein the above-described filtration-active fuel cell of the invention is used. For the purposes of the present invention, the term “fluids” encompasses both gases and liquids, while the term “liquids” refers to all fluids which are present in liquid form, preferably at temperatures of less than 100° C. and atmospheric pressure. In particular, liquids are, for the purposes of the present invention, both organic and/or aqueous liquids and also ionic liquids.

According to the present invention, the filtration-active fuel cell of the invention is preferably used for the processing of wastewater, particularly preferably of wastewater in sewage treatment plants.

In addition, the filtration-active fuel cell of the invention is, in a preferred embodiment, used for the purification of industrial wastewater, in particular for the treatment of wastewater from the pharmaceutical and food industry.

Furthermore, the filtration-active fuel cell of the invention is preferably used for the treatment and processing of drinkable liquids. For the purposes of the present invention, drinkable liquids encompass both alcohol-containing and alcohol-free liquids, with fruit juices, in particular apple juices, preferably being treated as alcohol-free liquids.

Supplying electric energy enables the filtration-active fuel cell of the invention also to be used for producing, for example, sodium hydroxide, hydrogen peroxide, ethanol and particularly preferably hydrogen.

Surprisingly and advantageously, the filtration-active fuel cell of the invention, in which the filtration-active layer of a membrane filter is simultaneously utilized as anode of a fuel cell, makes it possible for the energy efficiency of the membrane process to be increased and the operating costs to be reduced, so that membrane filtration becomes economical in a wider range of uses. According to the present invention, the combination of membrane filtration with a fuel cell for generating energy can be realized in a joint structure as a result of the configuration of the anode of a fuel cell in the form of a filtration-active layer, in contrast to the prior art which proposes coupling of membrane filtration and microbial fuel cells by connection in series. The filtration-active fuel cell of the invention therefore has a smaller outlay in terms of apparatus, as a result of which the energy consumption, particularly in the form of pump energy, and also the space requirement and capital costs can advantageously be reduced.

Compared to known systems in which the cathode of a microbial fuel cell is utilized for filtration purposes, the filtration-active fuel cell of the invention is characterized, in particular, in that known problems such as salting-up of the cathode and development of a pH gradient between anode and cathode are surprisingly avoided, as a result of which the function and the electric power of the fuel cell can be significantly improved. Furthermore, utilization of the anode rather than the cathode as filtration-active element makes it possible to realize the direct juxtaposition of anode, separator, cathode. This leads to a lower electrical resistance and thus to increased power of the fuel cell and also a lower outlay in terms of apparatus.

In addition, the combination of the two technologies, i.e. membrane filtration and fuel cell, in a single functional and integral structure makes it possible to reduce the energy consumption of the membrane filtration plant since materials present in the feed are, as energy carriers, converted directly into electric energy as a result of the oxidation. In this way, the operating costs of the membrane filtration in the treatment and processing of fluids, in particular liquids, can be reduced significantly and processes building on this, for example water-saving production processes, can be realized economically within a relatively wide range.

### Examples

The present invention is illustrated below with the aid of nonlimiting examples.

### Qualification of Porous Filter Materials as Anode

Firstly, sintered porous stainless steel and titanium filters were characterized as anodes in a half-cell set-up without filtration. Stainless steel filters having pore sizes of 1 μm, 0.5 μm, 0.3 μm and 0.1 μm and also titanium filters having pore sizes of 1 μm and 0.5 μm were tested. An acetate-containing carbonate buffer was used as medium. Geobacter sulfurreducens was used as exoelectrogenic bacteria and thus as catalyst.

The highest current density was achieved using stainless steel filters having a pore size of 1 μm. The achieved value of 600 μA/cm² at 0 V vs. SHE (standard hydrogen electrode) (cf. FIG. 6) is in the same range as that for knitted activated carbon (C-Tex13; ca. 700 μA/cm² at −89 mV vs. SHE), which counts as high-performance anode material. Compared to the stainless steel filters, titanium displays a somewhat lower current density.

### Half-Cell Experiments Under Cross-Flow Conditions

An adapted membrane holder which allows the installation of the above-described sintered metals and also a three-electrode arrangement with counterelectrode and reference electrode was constructed for a cross-flow filtration plant from Sartorius Stedim Biotech GmbH, SARTOFLOW® Study, by means of which both electrochemical and filtration-relevant measurements can be carried out. A corresponding experimental set-up is shown schematically in FIG. 7.

For this purpose, a filter membrane made of sintered metal (stainless steel having a nominal pore size of 0.5 μm) was operated as filtration-active anode having a geometric area of 10 cm² as half cell using synthetic wastewater. The synthetic wastewater contained acetate as carbon source in a neutral carbonate buffer and was stored in a 5 l reactor vessel under anaerobic conditions. The electroactive bacterium Geobacter sulfurreducens was used as active species.

At a flow velocity of 0.5 m/s over the membrane and a transmembrane pressure (TMP) of 1 bar, a permeate flux of 26 l/m² h was achieved after two days of operation, while the current density at the anode was established at 9 A/m² at 0 V vs. SHE in half-cell operation. After operation for two days with a varying TMP, a permeate flux of 13 l/m² h, which had been reduced by increasing fouling, was achieved by means of the same working example at 1 bar TMP and a flow velocity of 0.5 m/s over the membrane, and the current density at 0 V vs. SHE increased to 14 A/m².

### LIST OF REFERENCE NUMERALS

1 Feed
2 Particles/bacteria
3 Retentate
4 Filtrate/permeate
5 Wastewater, contains organic carbon compounds
6 Purified wastewater
7 Ion-conducting membrane
8 Anode compartment
9 Cathode compartment
10 Exoelectrogenic bacteria
11 Anode
12 Separator
13 Cathode
14 Hydrophobic membrane
15 Reference electrode
16 Counterelectrode

1. A filtration-active fuel cell for the filtration of fluids which comprises a filtration-active, electrically conductive membrane layer which simultaneously represents the anode of the fuel cell, a cathode, a fluid-permeable separator which spatially and electrically separates the cathode from the anode and an active species which is capable of oxidizing materials which are present in the feed and serve as energy carriers and transferring the liberated electrons to the anode.

2. The filtration-active fuel cell as claimed in claim 1, wherein the active species is selected from among microorganisms, enzymes and/or abiotic catalysts.

3. The filtration-active fuel cell as claimed in claim 1, which is in the form of a microbial fuel cell or an enzymatic fuel cell.

4. The filtration-active fuel cell as claimed in claim 1, wherein the active species is present in the form of a biofilm composed of microorganisms, preferably exoelectrogenic bacteria, arranged on the anode.

5. The filtration-active fuel cell as claimed in claim 1, which is present in the form of a membrane operated in the cross-flow mode.

6. The filtration-active fuel cell as claimed in claim 1, wherein the anode is an ultrafiltration membrane.

7. The filtration-active fuel cell as claimed in claim 1, wherein the anode has a hybrid construction in which filtration-active regions and electrically conductive regions alternate.

8. The filtration-active fuel cell as claimed in claim 1, which is present as hollow fiber module or tubular module.

9. The filtration-active fuel cell as claimed in claim 1, wherein the anode comprises an electrically conductive polymer material selected from among doped polymer materials based on polysulfone, polyether sulfone, polypropylene, polyvinylidene fluoride, polyacrylonitrile or polypyrrole, or an electrically conductive inorganic material selected from among carbon, ceramics and metals.

10. The filtration-active fuel cell as claimed in claim 1, wherein the anode comprises a TiO₂ ceramic or a porous sintered metal structure composed of titanium or (stainless) steel.

11. The filtration-active fuel cell as claimed in claim 1, wherein the cathode comprises an electrically conductive polymer material selected from among doped polymer materials based on polysulfone, polyether sulfone, polypropylene, polyvinylidene fluoride, polyacrylonitrile or polypyrrole, or an electrically conductive inorganic material selected from among carbon, activated carbon, ceramics and metals.

12. The filtration-active fuel cell as claimed in claim 1, wherein the cathode comprises activated carbon.

13. The filtration-active fuel cell as claimed in claim 1, wherein the cathode has a hydrophobic membrane which is permeable to oxygen on the surface facing away from the anode.

14. A method for treating and processing fluids comprising filtering a fluid through a filtration system comprising the filtration-active fuel cell according to claim 1.

15. The method as claimed in claim 14, wherein the fluid is wastewater or drinkable liquids.
